(19) United States
(12) Patent Application Publication
(10) Pub. No.: US 2021/0100215 A1
(43) Pub. Date: Apr. 8, 2021

(54) PET HOUSE-TRAINING PAD

(71) Applicant: William B Phelps, Bowie, MD (US)

(72) Inventor: William B Phelps, Bowie, MD (US)

(21) Appl. No.: 16/590,525

(22) Filed: Oct. 2, 2019

(51) Int. Cl. A01K 1/015

(52) U.S. Cl. CPC A01K 1/0157

(57) ABSTRACT

An illustrated view of an exemplary training pad 100 for house training a puppy is presented. The training pad is useful for providing a deterrent to pets chewing or tearing the training pad after they urinate or defecate on a training pad 100. The training pad is useful for aiding cleanup and making cleanup of a used training pad efficient, easier and safer. The training pad has an exterior lining that is leakproof. The training pad has an absorbent pad that is coupled to a middle of the exterior lining to absorb the urine or defecation of a pet. The absorbent pad has a pre-treated chew deterrent such as bitter apple and the like. The absorbent pad further has been pretreated with an odor neutralizer and a pheromone attractant.

### FIELD OF THE INVENTION

This invention relates to pet house training. More particularly, it relates to padding to aid in house training pets.

### BACKGROUND

The domestic dog (Canis lupus familiaris when considered a subspecies of the wolf or Canis familiaris when considered a distinct species) is a member of the genus Canis (canines), which forms part of the wolf-like canids, and is the most widely abundant terrestrial carnivore. The dog and the extant gray wolf are sister taxa as modern wolves are not closely related to the wolves that were first domesticated, which implies that the direct ancestor of the dog is extinct. The dog was the first species to be domesticated and has been selectively bred over millennia for various behaviors, sensory capabilities, and physical attributes.

Their long association with humans has led dogs to be uniquely attuned to human behavior and they are able to thrive on a starch-rich diet that would be inadequate for other canid species. Dogs vary widely in shape, size and colors. They perform many roles for humans, such as hunting, herding, pulling loads, protection, assisting police and military, companionship and, more recently, aiding disabled people and therapeutic roles. This influence on human society has given them the sobriquet of “man's best friend”.

It is estimated that three-quarters of the world's dog population lives in the developing world as feral, village, or community dogs, with pet dogs uncommon. “The most widespread form of interspecies bonding occurs between humans and dogs” and the keeping of dogs as companions, particularly by elites, has a long history.

However, pet dog populations grew significantly after World War II as suburbanization increased. In the 1950s and 1960s, dogs were kept outside more often than they tend to be today (using the expression “in the doghouse” to describe exclusion from the group signifies the distance between the doghouse and the home) and were still primarily functional, acting as a guard, children's playmate, or walking companion. From the 1980s, there have been changes in the role of the pet dog, such as the increased role of dogs in the emotional support of their human guardians. People and dogs have become increasingly integrated and implicated in each other's lives, to the point where pet dogs actively shape the way a family and home are experienced.

There have been two major trends in the changing status of pet dogs. The first has been the ‘commodification’ of the dog, shaping it to conform to human expectations of personality and behavior. The second has been the broadening of the concept of the family and the home to include dogs-as-dogs within everyday routines and practices.

There are a vast range of commodity forms available to transform a pet dog into an ideal companion. The list of goods, services and places available is enormous: from dog perfumes, couture, furniture and housing, to dog groomers, therapists, trainers and caretakers, dog cafes, spas, parks and beaches, and dog hotels, airlines and cemeteries. While dog training as an organized activity can be traced back to the 18th century, in the last decades of the 20th century it became a high-profile issue as many normal dog behaviors such as barking, jumping up, digging, rolling in dung, fighting, and urine marking (which dogs do to establish territory through scent), became increasingly incompatible with the new role of a pet dog. Dog training books, classes and television programs proliferated as the process of commodifying the pet dog continued.

Training a puppy to go to the bathroom is necessary for having a house dog. Having your dog go outside is the ideal solution, but potty pads can sometimes play a role in successful potty training. For example, with very young puppies it's necessary to make frequent trips outside. That might be too challenging for elderly owners or apartment dwellers. Or if you don't have a backyard and your dog's toilet area is a public place, you might want to limit your puppy's exposure until he's fully vaccinated. So, if you want to include potty pads in your puppy's housetraining routine, read on for tips on how to potty train a puppy on pads.

It's easy to get frustrated with your new puppy when potty training is taking longer than you expected. But it's essential to be patient during this process. Remember, potty training takes time. Don't expect more from your puppy than he is able to deliver. The following points will help you keep your cool:

A puppy can't control his bladder until he is 16 weeks old. So as much as you might like him to wait, he simply can't.

A puppy can only hold his bladder as long as his age in months plus one hour. So, a four-month-old puppy can only hold it for five hours. That includes during the night as well.

Every breed is different. For example, a toy breed might need more frequent potty breaks due to a fast metabolism and tiny bladder.

Every puppy is different, even within breeds. Your first puppy might have been potty trained in a few weeks, but your next one might need months.

Since puppies are often playful and curious, they tend to chew on things either because of their curious nature, to beg for attention, to display a temper, etc. When using a pad for training a puppy, the puppy often times will chew on or destroy the pad. This causes longer training, messy situations, higher cost of training, etc.

In light of the foregoing, there is a need to provide a device to cease the puppy from chewing or trying to destroy the pad. This will lower costs and has a great potential to shorten the training period.

### BRIEF DESCRIPTION OF THE DRAWINGS

FIG. 1 is an illustrated view of an exemplary training pad.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

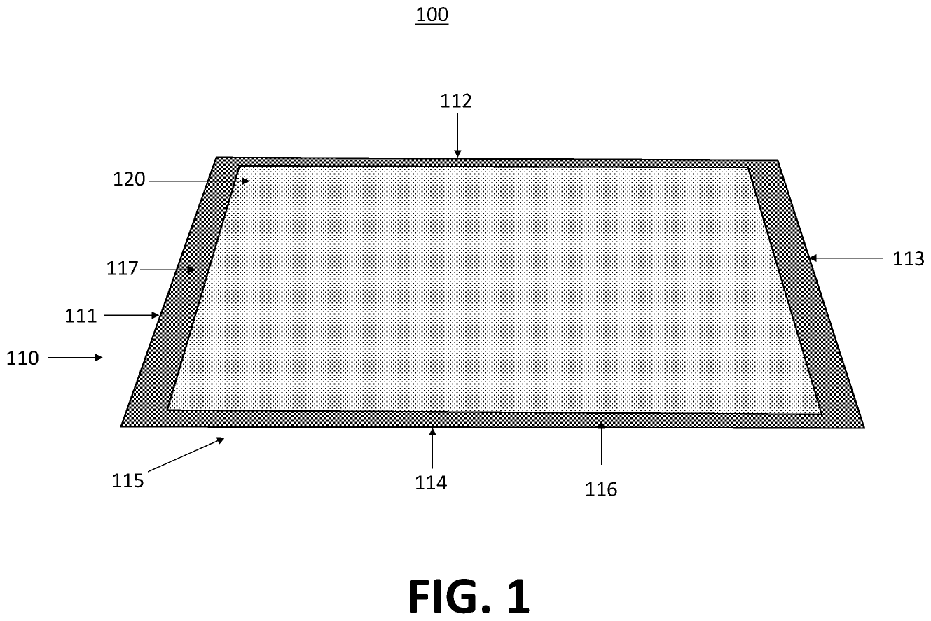

Referring to FIG. 1, an illustrated view of an exemplary training pad 100 for house training a puppy is presented. The training pad 100 is useful for providing a deterrent to pets chewing or tearing the training pad 100 after they urinate or defecate on a training pad 100. The training pad 100 is useful for aiding cleanup and making clean up of a used training pad 100 efficient, easier and safer.

The training pad 100 has an exterior lining 110 and an absorbent pad 120. The exterior lining 110 is preferably leakproof. The exterior lining 110 is preferably made of a polyurethane laminate (PUL) material, however other materials are hereby contemplated, including, but not limited to, plastic, vinyl, nylon, etc. The training pad 100 is preferably twenty-eight (28) inches in length, however other lengths are hereby contemplated, including, but not limited to, twenty-three (23) inches, twenty-seven and one-half (27.5) inches, etc. The training pad 100 is preferably thirty-four (34) inches in width, however other widths are hereby contemplated, including, but not limited to, twenty-four (24) inches, forty-four (44) inches, etc. The training pad 100 is preferably a substantially square shape.

The exterior lining 110 has a first edge 111, a second edge 112, a third edge 113, a fourth edge 114, a back 115 and a top 116. The top 116 of the exterior lining 110 has a middle portion 117.

The absorbent pad 120 is coupled to substantially the middle portion 117 of the top 116 of the exterior lining 110 by a coupling device (not shown). The coupling device is preferably an adhesive coupler, however other coupling agents are hereby contemplated, including, but not limited to, Velcro, tape, etc.

The absorbent pad 120 is preferably made of five layers. The absorbent pad 120 preferably is configured to contain ten (10) cups of liquid, however other amounts of liquid are hereby contemplated, including, but not limited to eight (8) cups, fourteen (14) cups, etc. The absorbent pad 120 preferably has a length of twenty-four (24) inches, however other lengths are hereby contemplated, including, but not limited to, twenty (20) inches, twenty-three (23) inches, etc. The absorbent pad 120 must be at least significantly smaller in length than the exterior lining 110.

The absorbent pad 120 preferably has a width of twenty-nine (29) inches, however other lengths are hereby contemplated, including, but not limited to, twenty-one (21) inches, forty (40) inches, etc. The absorbent pad 120 must be at least significantly smaller in width than the exterior lining 110. The absorbent pad 120 is preferably substantially square in shape. The absorbent pad 120 is preferably absorbent.

The absorbent pad 120 is configured to have a chew deterrent administered. The chew deterrent preferably has an undesirable taste. The undesirable taste is preferably a bitter apple flavor, however other flavors are hereby contemplated, including, but not limited to, vinegar, bitter citrus, bitter cherry, bitter lemon, peppery flavor, etc.

The absorbent pad 120 preferably is configured to have an odor neutralizer. Further the absorbent pad 120 preferably is configured to have a pheromone attractant.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A training pad for house training a pet, the pad comprising:
an exterior lining, the exterior lining for providing a lining for the pad′ an absorbent pad, the pad being coupled to a middle portion of a top of the pad; and
a chew deterrent, wherein the chew deterrent being applied to the absorbent pad to deter chewing of the pad by the pet.

2. The pad of claim 1, wherein the exterior lining being a polyurethane laminate (PUL).

3. The pad of claim 1, wherein the exterior lining being leakproof.

4. The pad of claim 1, wherein the exterior lining having a length being twenty-eight (28) inches.

5. The pad of claim 1, wherein the exterior lining having a width being thirty-four (34) inches.

6. The pad of claim 1, wherein the exterior lining being substantially square in shape.

7. The pad of claim 1, wherein the absorbent pad being coupled to the exterior lining by an adhesive material.

8. The pad of claim 1, wherein the absorbent pad having a length being twenty-four (24) inches.

9. The pad of claim 1, wherein the absorbent pad having a width being twenty-nine (29) inches.

10. The pad of claim 1, wherein the exterior lining being greater in length than the absorbent pad.

11. The pad of claim 1, wherein the exterior lining being greater in width than the absorbent pad.

12. The pad of claim 1, wherein the chew deterrent being bitter apple.

13. The pad of claim 1, wherein the absorbent pad being five layers.

14. The pad of claim 1, wherein the absorbent pad being configured to hold ten (cups) of liquid.

15. The pad of claim 1, wherein the absorbent pad being further configured to be treated with a pheromone attractant.

16. The pad of claim 1, wherein the absorbent pad being further configured to be treated with a odor neutralizer.
